(19) United States
(12) Patent Application Publication
(10) Pub. No.: US 2006/0182563 A1
(43) Pub. Date: Aug. 17, 2006

(54) Lifting system

(76) Inventors: Jurjen Jan De Jong, Waterlelie (NL); Jan Berends, De Zeilen (NL)

Correspondence Address: HARNESS, DICKEY & PIERCE, P.L.C., P.O. BOX 8910, RESTON, VA, 20195, US

(21) Appl. No.: 11/314,415

(22) Filed: Dec. 22, 2005

(30) Foreign Application Priority Data
Dec. 23, 2004 (NL) 1027870

(51) Int. Cl. B65G 7/00

(52) U.S. Cl. 414/427

(57) ABSTRACT

The present invention relates to a lifting system. The lifting system comprises at least two lifting devices, which each have at least an ascent mode and a descent mode under the influence of a control. The two lifting devices comprise a frame, a cylinder coupled to the frame as drive for at least the ascent or descent of the frame; pump means which are connected to the cylinder via a connection, correction means which can be energized selectively and which are connected to the connection, and a descent valve which can be energized selectively and which is connected to at least the cylinder, wherein the correction means can be energized by the control at least separately of the descent valve in at least the descent mode.

The present invention relates to a lifting system which comprises at least two lifting devices, such as a system with lifting columns or a car lift. Each of the lifting devices has at least one ascent mode and one descent mode, and are under the influence of a control. The control can be designed for each lifting device individually, or for the lifting devices together. Each lifting device comprises a frame, a cylinder coupled to the frame as drive for at least the ascent or descent of the frame, pump means which are connected to the cylinder via a connection, correction means which can be energized selectively and which are connected to the connection, and a descent valve which can be energized selectively and which is connected to at least the cylinder.

In normal operation hydraulic or pneumatic fluids are sent to the cylinder by the pump means during ascent of the lifting system. These can be pump means per lifting device, or pump means can also be applied for a number of the lifting devices simultaneously.

For synchronization of the lifting devices, each comprises the correction means. These can discharge a part of the fluids sent to the cylinder by the pump means before they reach the cylinder. One of the lifting devices in a higher position can thus be slowed down during ascent when the correction means are energized until the lifting devices have once again reached the same height, wherein the correction means can be deactivated again.

A possible cause for such height differences of lifting devices in ascent mode can be individual variations in the properties of the pump means, properties of cylinders, load per lifting column etc.

During the descent of the lifting system with each of the lifting devices in a descent mode a descent valve can be energized, which is thus connected to the cylinder. The descent valve provides for discharge of fluids from the cylinder. The descent valve has properties and characteristics with which substantially a single descent speed can be realized. For synchronization purposes the correction means can be used to accelerate a higher of the lifting devices in a descending movement, and thus once again bring the diverse lifting devices to the same height. Nevertheless, substantially one descent speed is here aimed for and realized, which is then in any case related to the descent speed of a lifting device which at any given moment is in a lower position.

A lifting system as described above and defined in the preamble of claim 1 is known from EP-A-1 046 608.

The present invention has for its object to provide a new and innovative lifting system with which in general a higher degree of flexibility can be provided and in particular a large diversity of ascent and descent speeds can be realized. The present invention also has for its object to provide a lifting system with a wider range of control options.

For this purpose a lifting system according to the present invention is distinguished by the features defined in the characterizing parts of the independent claims.

The correction means can thus play a part independently of the descent valve in the descent mode, and a higher or lower descent speed associated with the correction means can be achieved than when this is determined only by the descent valve. Separate speeds can thus be realized in the descent mode by making a choice between the descent valve and/or the correction means. In the prior art it was usual to energize the descent valve in a descent mode so as to accelerate a higher of the lifting devices in the downward movement, when the correction means are then additionally energized. According to the present invention it is possible for the descent valve and the correction means to be normally jointly energized in the descent mode in order to bring about an accumulated descent speed, wherein in the descent mode the correction means of a lower of the lifting devices can be closed or refrain from further energizing so as to allow the other lifting device or lifting devices to draw level with the relevant lifting device in the descending movement.

A similar option exists in the ascent mode, wherein the correction means can for instance be energized as standard for closing thereof in a lower of the lifting devices so that the relevant lifting device can draw level with the other lifting devices with a higher ascent speed.

Through the use of the correction means separately and instead of the descent valve in the descent mode, even more individual descent speeds can be provided, and, due to the modes of use with diverse basic principles, such as allowing lagging lifting devices to draw level in an ascent or descent mode, etc., a greater degree of freedom is provided in the choice of operating principle of the control system without the complexity of the hydraulic or pneumatic circuit being increased to any extent for this purpose. The use of the correction means alone allows a slow descent speed.

In a preferred embodiment a lifting system according to the invention has the feature that the correction means and the descent valve each comprise a throttle, and a throughflow capacity of the throttle of the correction means is lower than that of the throttle of the descent valve. This lower throughflow capacity of the throttle is also referred to as a throttling for the purpose of bringing about a defined volume flow therethrough. If in a descent mode energizing of the correction means is then chosen instead of energizing of the descent valve, a considerably lower descent speed can be provided than that associated with the descent valve. A control can thus be made possible wherein the lifting system descends rapidly to a position close to the lower point hereof, and can then complete the descending movement at a much slower speed by switching from energizing of the descent valve to energizing of the correction means alone. The lifting devices of the lifting system then arrive at the lowest point of the lifting system at a low speed, which means that an object lifted and lowered again by the lifting system, such as a vehicle, is lowered slowly and carefully.

The lifting system can herein have the feature that a descent speed associated with the throughflow capacity of the throttle of the correction means is at least approximately ⅓ of a descent speed associated with the throughflow capacity of the throttle of the descent valve. This is based on a number of practical considerations. It is particularly the case that descent valves have variations in individual products in respect of the properties thereof, such as the throughflow capacity. This individual variation in the throughflow capacity of a descent valve can amount to 20%. The descent speeds of individual lifting devices realized with the descent valves can thus also differ 20% from each other. If correction means can be expected to compensate detected differences in descent speeds and then also obviate differences in height once these have been detected, the correction means must have a throughflow capacity associated with a descent speed of higher than 20%. Through an inventive choice of ⅓ extra capacity is also provided for obviating height differences between the lifting devices once these occur and are detected.

In a preferred embodiment a lifting system according to the present invention has the feature that the control is adapted to detect height differences between lifting devices and to energize at least the correction means of a highest of the lifting devices. During both ascent and descent of the lifting system a lower or the lowest of the lifting devices can thus be used as reference, relative to which higher lifting devices are accelerated in a descending movement or slowed in an ascending movement thereof. A reverse principle is of course also possible within the scope of the present invention, when the control is adapted to energize the correction means as standard in the ascent mode and to deactivate them in lower lifting devices, while the descent valve and the correction means can be energized as standard in a descent mode, wherein the correction means can be deactivated in order to slow down a lower lifting device in a descending movement and allow the higher lifting devices to draw level therewith, etc.

In such an embodiment it is possible for the control to be adapted to optionally energize the correction means and the descent valve in synchronized manner and jointly or individually as desired. This demonstrates how wide the diversity of control options becomes when the present invention is applied.

It is also possible here for the control to be adapted to optionally energize the descent valve and the correction means when a detected height difference is greater than a predetermined threshold value. The choice of such a threshold value is preferably related to the parameters of the pump means, the descent valve and the correction means in respect of the speeds of ascent and descent influenced thereby, as already discussed above. Once height differences have been detected, the differences in speed which are the cause thereof must be obviated and the height differences which have meanwhile occurred must be eliminated. A determined degree of overcapacity is necessary for this purpose in the correction means. The threshold value for switching between descent valve and correction means is preferably chosen such that the desired correction and compensation can be realized within the overcapacity of the correction means. The threshold value can herein correspond to a height difference in the range of at least approximately 0.05 to 2.5% of the maximum ascent height of the lifting system. The speed at which compensation and correction can take place can thus be related to the maximum ascent height and the speed relative to the maximum ascent speed at which compensation and correction can take place. In a preferred embodiment the threshold value can amount to at least approximately 1.5 cm, in particular for lifting columns.

It is noted that the present invention not only relates to a whole lifting system with a number of lifting devices and a control, which control can possibly be provided per lifting device or as a single unit for the whole lifting system, but that the invention also provides separate protection to lifting devices for such a lifting system and a control for such a lifting system.

An exemplary embodiment of a lifting system according to the present invention is described hereinbelow on the basis of a non-limitative exemplary embodiment thereof shown in the accompanying drawings, wherein:

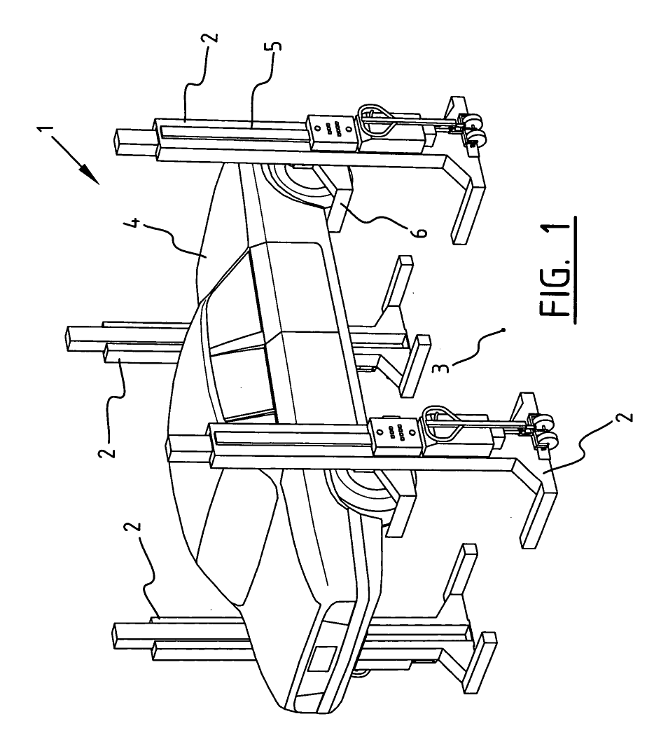

FIG. 1 shows a perspective view of a lifting system according to the present invention in operation; and

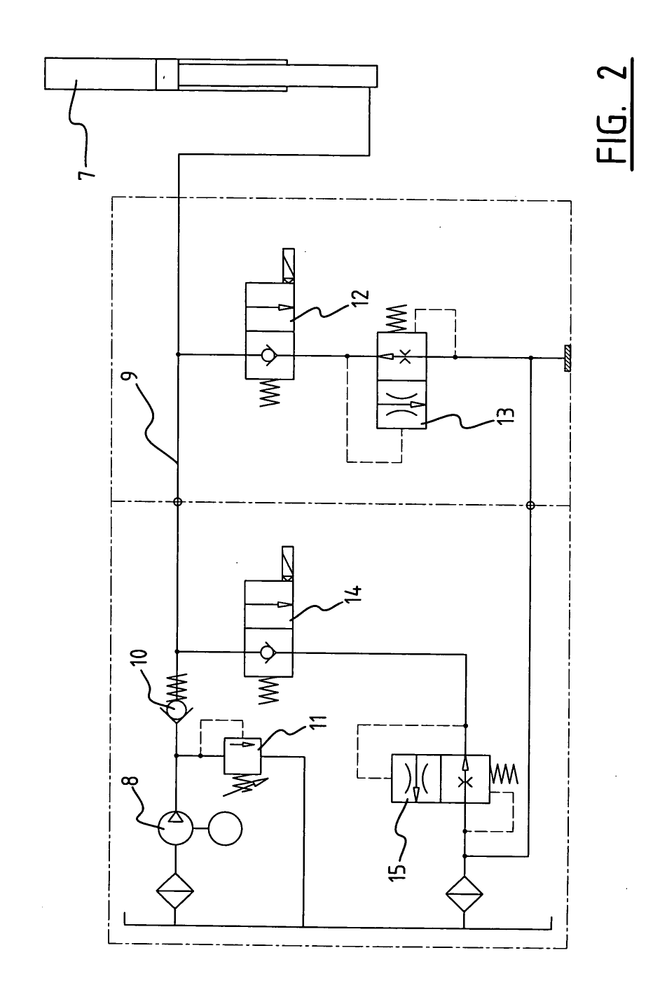

FIG. 2 shows a schematic exemplary embodiment of a hydraulic control system, with which diverse operating principles can be realized in the ascent and descent according to the present invention.

FIG. 1 shows a lifting system 1 assembled from four lifting columns 2 forming lifting devices. Lifting columns 2 can be mutually connected in radiographic manner or via cables for exchange of control signals. Lifting system 1 serves to lift a vehicle 4 and setting it down again on the ground 3. The lifting system thus has an ascent mode and a descent mode, in which lifting columns 2 must be as synchronized as possible.

An electrical/hydraulic control system of one of lifting columns 2 will be described with reference to FIG. 2. This does however takes place in conjunction with other lifting columns 2 on the basis of detected height differences between lifting columns 2. Lifting columns 2 each comprise a mast 5 along which a carrier 6 can be moved, wherein carrier 6 serves to engage a wheel of vehicle 4. In the embodiment shown here carrier 6 is displaceable along mast 5 by means of a hydraulic cylinder 7. Mast 5 forms part of the lifting device and is in fact a frame along which carrier 6 can thus be displaced. Cylinder 7 is situated between the foot of mast 5 or the top of mast 5 and carrier 6 for the purpose of driving this carrier 6 in a movement along mast 5.

Hydraulic cylinder 7 is connected for this purpose to a pump 8 via a connection 9. A non-return valve 10 is incorporated in connection 9 to prevent hydraulic fluid being able to flow back to pump 8 along connection 9 when pump 8 is deactivated.

In an ascent mode of a lifting column 2 the pump 8 is energized. Non-return valve 10 is herein pressed aside and connection 9 is released for throughflow of hydraulic fluid to cylinder 7. If cylinder 7 is too heavily loaded here, the pressure in connection 9 rises sharply. To prevent this causing damage a pressure-relief valve 11 is provided, which opens at a predetermined threshold value of the pressure in connection 9, for instance 265 bar.

If a control detects through exchange of data relating to heights reached between the diverse lifting columns 2 that lifting column 2, the hydraulic system of which is shown in FIG. 2, has reached a greater height than one or more than one of the other lifting columns 2 in lifting system 1 in FIG. 1, a normally closed correction valve is energized to allow passage of hydraulic fluid from connection 9 to a pressure-compensated volume flow control valve 13, which for instance has a throughflow capacity of 2 l./min. The ascent speed of cylinder 7 generated by pump 8 can thus be reduced via correction valve 12, when it is energized, and the pressure-compensated volume flow control valve 13 to allow the other lifting columns 2 to be able to draw level with the height reached.

After the desired height of lifting system 1 is (has been) reached, the descent of lifting system 1 can begin. For this purpose pump 8 is deactivated and a conventional descent valve 14 can be energized in order to leave clear a passage to a pressure-compensated volume flow control valve 15 functioning as a throttle, which has for instance a throughflow capacity of 6 l./min.

If any of the lifting columns 2 of FIG. 1 lags behind, the correction valve can also be energized to increase the descent speed, since the pressure-compensated volume flow control valve 13, which is associated with correction valve 12 and which likewise serves as throttle, provides an additional throughflow capacity relative to the pressure-compensated volume flow control valve 15 in descent valve 14.

According to the present invention it is therefore possible to energize not the descent valve 14 but the correction valve 12. A considerably lower descent speed can hereby be realized. In respect of the throughflow capacities of the pressure-compensated volume flow control valves 13 and 15 it is noted that, when only the correction valve is energized without the descent valve being energized, a descent speed is achieved which amounts to only ⅓ of the descent speed if only the pressure-compensated volume flow control valve 15 were energized. In order to ensure synchronization in this descent mode with a lower descent speed, a lower of the lifting columns 2 can be temporarily stopped in the downward movement by deactivating the energizing of correction valve 12, while the energizing of descent valve 14 remains deactivated.

In an operative mode, where descent valve 14 is energized, the branch via correction valve 12 can produce a higher descent speed to cause a higher of the lifting columns to descend in accelerated manner and draw level with the other lifting columns 2 in the downward movement.

According to the present invention many diverse control principles are possible, which are oriented toward higher or lower lifting devices, wherein it is possible to opt for standard speeds which are determined during ascent only by the motor, with correction valve 12 as adjustment possibility, or a lower speed which is determined by pump 8 with correction valve 12 in energized state as standard, where correction valve 12 can be temporarily deactivated to allow a lower lifting column to be able to draw level with the rest. In a descent mode of lifting system 1 the control can also be oriented toward higher or lower lifting columns 2, wherein only the descent valve is energized as standard, the descent valve and the correction valve are energized as standard, or only correction valve 12 is energized as standard so as to determine the standard speed during descent and therein provide correction possibilities. It is also possible to envisage control modes wherein the conventional descent valve 14 can be used as a type of correction valve and can be energized temporarily in an ascent mode of lifting system 1 to slow down even more strongly a higher lifting device which is running very far ahead. The functions of correction valve 12 and descent valve 14 are thus mutually interchangeable, both during ascent and descent.

1. Lifting system, comprising at least two lifting devices, which each have at least an ascent mode and a descent mode under the influence of a control, and comprise:
a frame;
a cylinder coupled to the frame as drive for at least the ascent or descent of the frame;
pump means which are connected to the cylinder via a connection,
correction means which can be energized selectively and which are connected to the connection; and
a descent valve which can be energized selectively and which is connected to at least the cyclinder, wherein:
the control is adapted to energize the correction means in at least a descent operating mod with the descent valve in a non-energized state.

2. Lifting system as claimed in claim 1, wherein the correction means and the descent valve each comprise a throttle, and a throughflow capacity of the throttle of the descent valve.

3. Lifting system as claimed in claim 2, wherein a descent speed associated with the throughflow capacity of the throttle of the correction means amounts to at least approximately one third of a descent speed associated with the throughflow capacity of the descent valve.

4. Lifting system as in claim 1, wherein the control is adapted to detect height differences between lifting devices and to close at least the correction means of a lowest of the lift devices.

5. Lifting system as in claim 1, wherein the control is adapted to detect height differences relative to substantially the highest of the lifting devices.

6. Lifting system as in claim 4, wherein the control is adapted to optionally energize the correction means and the descent valve in synchronized manner and jointly or individually as desired.

7. Lifting system as in claim 6, wherein the control is adapted to optionally energize the descent valve and the correction means when a detected height difference is greater than a predetermined threshold value.

8. Lifting system as claimed in claim 7, wherein the threshold value corresponds to a height difference in the range of at least approximately 0.05 to 2.5% of a maximum ascent height of the lifting system.

9. Lifting system as claimed in claim 8, wherein the threshold value amounts to at least approximately 1.5 cm.

10. Lifting device for a lifting system as in claim 1.

11. Control for a lifting system as in claim 1.

12. Method for controlling a lifting system, comprising:
a frame;
a cylinder coupled to the frame as drive for at least the ascent or descent of the frame;
pump means which are connected to the cylinder via a connection, correction means which can be energized selectively and which are
connected to the connection; and
a descent valve which can be energized selectively and which is
connected to at least the cylinder,
wherein selectively energizing the correction means in at least a descent operating mode with the descent valve in a non-energized state.
